(19) United States
(12) Patent Application Publication
(10) Pub. No.: US 2019/0025914 A1
(43) Pub. Date: Jan. 24, 2019

(54) FINGER CONTROL DEVICE COMBINABLE WITH BLUETOOTH FUNCTIONS

(71) Applicant: Po-Hsun Fan, New Taipei City (TW)

(72) Inventor: Po-Hsun Fan, New Taipei City (TW)

(21) Appl. No.: 15/654,674

(22) Filed: Jul. 19, 2017

(51) Int. Cl. G06F 3/01; H04M 1/725; G06K 9/00; H04W 4/00; G06F 3/0346

(52) U.S. Cl. CPC G06F 3/014; H04M 1/7253; G06K 9/00375; G06F 3/017; G06F 3/0346; G06K 9/00624; H04W 4/008

(57) ABSTRACT

A finger control device combinable with Bluetooth functions includes: a finger stall unit, having a base part and five finger stall tubes in connection therewith, the finger stall tubes allowing five fingers of a hand corresponding thereto to be passed through, and an inner part of a tube wall of each finger stall tube in combination with a sensing line adapted to sense bending movements and times of the corresponding finger, and the base part configured with a first connection in electric connection with the sensing lines respectively through a signal transmission line; and a Bluetooth unit, provided with a second connection in connection with the first connection, and adapted to receive signals sensed by the sensing lines, convert the signals to Bluetooth signals and transmit the Bluetooth signals to an electronic product in pairs with the Bluetooth unit so as to control the operation of the electronic product.

### TECHNICAL FIELD OF THE INVENTION

The present invention relates to a finger control device that can be combined with Bluetooth functions, and more particularly to a device adapted to control electronic products by sensing the bending movements and times of each finger and converting them to Bluetooth signals.

### DESCRIPTION OF THE PRIOR ART

Bluetooth is a technical standard using short-wave very-high-frequency (VHF) radio waves for wireless transmission, allowing a fixed device and mobile device to exchange data in a short distance to form a personal area network; its applications are spread over telecommunications, computers, networks and consumer electronics such as smart phones, tablets, VR hoods, headphones, Google eye glasses, and multimedia players. Users can share information in these portable devices with the systems in electronics through Bluetooth pairing.

For example, an address book in a mobile phone can be read by means of direct voice dialing through the voice recognition function of CUE system; music files in a mobile phone or multimedia player can be read, and played in vehicle stereo through CUE system, and track names, lyrics, album cover images and etc can be displayed on the screen of CUE system.

In addition, Bluetooth can also allow wireless connection among different electric devices, for example, connection to computers and peripherals such as printers, keyboards. Furthermore, it may allow a personal digital assistant (PDA) to communicate with other PDAs or computers around. Mobile phones of Bluetooth technology can be in connection with computers, PDAs, and even hands-free handsets.

Although Bluetooth transmission technology have been commonly used, fingers, traditionally, still must be used to press keys or touch a touch screen to obtain required functions in a practical operation, which is not very convenient.

Currently very popular virtual reality (VR) devices or video game devices must be held by a user's hand at the relating handheld part of each of them when the information transmission between the devices is carried out with Bluetooth.

### SUMMARY OF THE INVENTION

An objective of the present invention is to provide a finger control device, sensing the bending movements and times of each finger and converting them to Bluetooth signals so as to control electronic products.

To achieve the object mentioned above, the present invention proposes a finger control device combinable with Bluetooth functions, including: a finger stall unit, having a base part and five finger stall tubes in connection with the base part, the finger stall tubes allowing five fingers of a hand corresponding thereto to be passed through, and an inner part of a tube wall of each finger stall tube in combination with a sensing line adapted to sense bending movements and bending times of the corresponding finger, and the base part configured with a first connection in electric connection with the sensing lines respectively through a signal transmission line; and a Bluetooth unit, provided with a second connection in connection with the first connection, and adapted to receive signals sensed by the sensing lines, convert the signals to Bluetooth signals and transmit the Bluetooth signals to an electronic product in pairs with the Bluetooth unit so as to control the operation of the electronic product.

Preferably, the base part is a sheet material corresponding to the shape of the back of a hand, thereby allowing the back of a hand to bear the base part.

Preferably, the lengths of the finger stall tubes respectively correspond to the ones of first knuckles of the five fingers, thereby allowing the second and third knuckles of each finger to be bent flexibly.

Preferably, the first connection is configured on one side of the base part opposite to the finger stall tubes, conducive to the connection thereof with the Bluetooth unit worn on a wrist.

Preferably, the Bluetooth unit includes a mainframe and a collar in connection with the mainframe, and the collar is capable of being worn on a wrist, thereby allowing a user to use the finger movements to control the movements and functions of an electronic device in pairs therewith, and realizing the comfortable experience of man-machine integration.

### BRIEF DESCRIPTION OF THE DRAWINGS

FIG. 1 is a schematic view of the structure and connection relationship of a finger stall unit and Bluetooth unit of the present invention;

FIG. 2 is a perspective view of the finger stall unit and Bluetooth unit of the present invention in connection with each other and worn on a user's hand; and

FIG. 3 is a perspective view of the finger stall unit and Bluetooth unit of the present invention worn on a user's hand, with the user holding a pen to write.

### DETAILED DESCRIPTION OF THE PREFERRED EMBODIMENTS

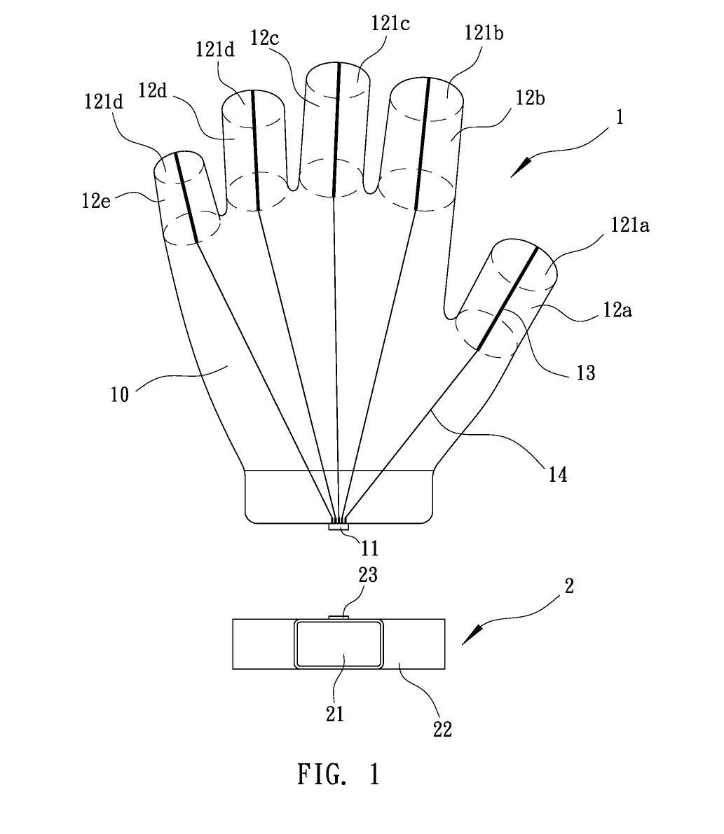

Referring to FIG. 1, a finger control device combinable with Bluetooth functions of the present invention, in a preferred embodiment, includes a finger stall unit 1 and Bluetooth unit 2, where the finger stall unit 1 has a base part 10 and five finger stall tubes 12a, 12b, 12c, 12d and 12e in connection with the base part 10 respectively formed with a hollow portion 121a, 121b, 121c, 121d and 121e allowing five fingers to be passed through, namely, the thumb is passed through the hollow portion 121a of the finger stall tube 12a, the forefinger the hollow portion 121b of the finger stall tube 12a, the middle finger the hollow portion 121c of the finger stall tube 12c, the ring finger the hollow portion 121d of the finger stall tube 12d, and the little finger the hollow portion 121e of the finger stall tube 12e. More specifically, the finger stall unit 1 may be made of any proper material such as cloth and formed into a body shaped like a glove but only have the base part 10 capable of covering the back of a hand (the surface of a hand opposite to a palm) without covering the palm, i.e. the base part 10 is a sheet material corresponding to the back part of a hand; the finger stall tubes 12a-12e are spread on the front side of the base part 10 and respectively have different lengths respectively corresponding to the lengths of the first knuckles of general human fingers.

For example, the length of the finger stall tube 12a corresponds to the one of the first knuckle of a thumb, allowing the first knuckle of the thumb to be covered by the finger stall tube 12a after the thumb is passed through the finger stall tube 12a, the length of the finger stall tube 12b the one of the first knuckle of a forefinger, allowing the first knuckle of the forefinger to be covered by the finger stall tube 12b after the forefinger is passed through the finger stall tube 12b, the length of the finger stall tube 12c the one of the first knuckle of a middle finger, allowing the first knuckle of the middle finger to be covered by the finger stall tube 12c after the middle finger is passed through the finger stall tube 12c, the length of the finger stall tube 12d the one of the first knuckle of a ring finger, allowing the first knuckle of the ring finger to be covered by the finger stall tube 12d after the ring finger is passed through the finger stall tube 12d, and the length of the finger stall tube 12e the one of the first knuckle of a little finger, allowing the first knuckle of the little finger to be covered by the finger stall tube 12e after the little finger is passed through the finger stall tube 12e.

The first knuckle mentioned above refers to the distance from the root of a finger to the first joint thereof, and thus, the second and third knuckles of each finger will be exposed out of the corresponding finger stall tube 12a-12e after each finger is passed through the corresponding finger stall tube 12a-12e.

Furthermore, the inner parts of the tube walls of the finger install tubes 12a-12b are respectively in combination with a sensing line 13 capable of being a general conductive metal line adapted to sense the bending movements and times of each finger; the sensing line 13 may be inserted in the tube wall of each finger stall tube 12a-12e by weaving upon the making of the finger stall unit 1.

Furthermore, the base part 10 is provided with a first connection 11 in electric connection with the sensing lines 13 respectively through a signal transmission line 14. Preferably, the first connection 11 is configured on one side of the base part 10 opposite to the finger stall tubes 12a-12e.

The Bluetooth unit 2 of the present invention has a mainframe 21 and a collar 22 in connection with the mainframe 21, where a control chip (not shown in the figures) is configured inside the mainframe 21, and the mainframe 21 is provided with a second connection 23 exposed out thereof, capable of being coupled to the first connection 11 so as to be in electric connection therewith. Here, the collar 22 may be an elastic band or a band body like watch strap, allowing it to be worn on a user's wrist.

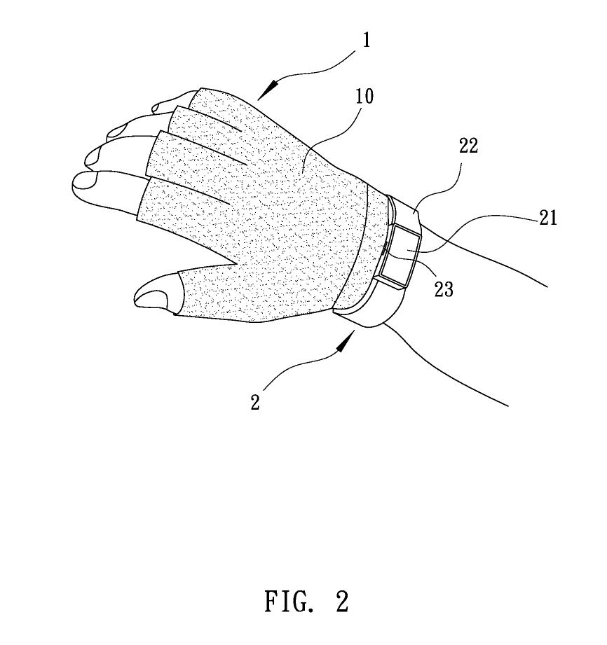

When the finger control device is used, the Bluetooth unit 2 is first worn on a user's wrist, and the finger stall unit 1 is then worn on the user's fingers and the back of the user's hand, allowing the first connection 11 to be coupled to the second connection 23 as FIG. 2 shows. At this time, with the programs preset by the control chip inside the mainframe 21, the bending movements and times of the finger corresponding to each sensing line 13 attached thereto can be sensed when the user's hand on which finger stall unit 1 and Bluetooth unit 2 are worn moves about. As a result, sensed signals are transmitted to the control chip inside the mainframe 21 of the Bluetooth unit 2 through each signal transmission line 14, and the control chip then converts the signals to Bluetooth signals and transmits them to an electronic product paired with the Bluetooth unit 2 so as to control the operation of the electronic product.

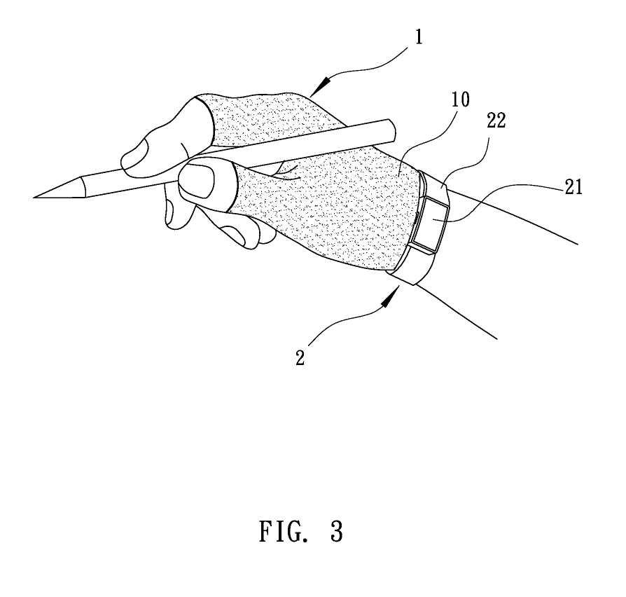

Referring to FIG. 3, for example, when a user uses the hand worn with the finger stall unit 1 and Bluetooth unit 2 to hold a pen to write or draw, each sensing line 13 will sense the bending movements and bending times of the corresponding finger, and the sensed signals will then sent to the control chip inside the mainframe 21 of the Bluetooth unit 2 through each signal transmission line 14. Thereafter, the control chip converts the signals to Bluetooth signals and transmits them to an electronic product in pairs with the Bluetooth unit 2 so as to control the electronic product to generate the functions corresponding to the pen movement mode.

Thereupon, a user can control the movements or functions of a paired electronic device through the finger movements by the finger control device combinable with Bluetooth functions of the present invention, which realizes the comfortable experience of man-machine integration.

1. A finger control device combinable with Bluetooth functions, comprising:
a finger stall unit, having a base part and five finger stall tubes in connection with said base part, said finger stall tubes allowing five fingers of a hand corresponding thereto to be passed through, and an inner part of a tube wall of each said finger stall tube in combination with a sensing line adapted to sense bending movements and bending times of said corresponding finger, and said base part configured with a first connection in electric connection with said sensing lines respectively through a signal transmission line; and
a Bluetooth unit, provided with a second connection in connection with said first connection, and adapted to receive signals sensed by said sensing lines, convert said signals to Bluetooth signals and transmit said Bluetooth signals to an electronic product in pairs with said Bluetooth unit so as to control the operation of said electronic product,
wherein the sensing lines are inserted in the tube walls of the finger stall tubes by weaving.

2. The device according to claim 1, wherein said base part is a sheet material corresponding to the shape of the back of a hand.

3. The device according to claim 2, wherein the lengths of said finger stall tubes respectively correspond to the ones of first knuckles of said five fingers.

4. The device according to claim 3, wherein said first connection is configured on one side of said base part opposite to said finger stall tubes.

5. The device according to claim 4, wherein said Bluetooth unit comprises a mainframe and a collar in connection with said mainframe, and said collar is capable of being worn on a wrist.
